(19) United States
(12) Patent Application Publication
(10) Pub. No.: US 2021/0220097 A1
(43) Pub. Date: Jul. 22, 2021

(54) DENTAL TOOL WITH LIQUID APPLICATOR AND VACUUM CHANNEL

(71) Applicant: Bio-Life Innovations, LLC, North Canton, OH (US)

(72) Inventor: David J. Boord, North Canton, OH (US)

(21) Appl. No.: 17/155,474

(22) Filed: Jan. 22, 2021

Related U.S. Application Data
(60) Provisional application No. 62/964,615, filed on Jan. 22, 2020.
(60) Provisional application No. 63/004,324, filed on Apr. 2, 2020.

(51) Int. Cl. A61C 17/08; A61C 17/06; A46B 5/00

(52) U.S. Cl. CPC A61C 17/08; A46B 5/0037; A61C 17/065

(57) ABSTRACT

This disclosure relates to a device to break down biofilm and selectively supply liquid in the mouth. An examples head for a dental tool includes body, a front surface, and a back surface. The body define a chamber to contain a substance and a vacuum channel separate from the chamber to fluidly connect to a vacuum supply. The front surface includes a brush plate with brush teeth. The brush plate defines a wall of the chamber. The front surface also defines distribution holes in fluid connection with the chamber. The back surface is opposite the front surface. The back surface defines a vacuum port in fluid connection with the vacuum channel.

### RELATED APPLICATIONS

This application claims priority to U.S. Provisional Application No. 62/964,615 filed on Jan. 22, 2020, and U.S. Provisional Application No. 63/004,324 filed on Apr. 2, 2020, which are incorporated herein by reference in their entirety.

### TECHNICAL FIELD

The present invention is generally related tools used in dentistry and/or oral and maxillofacial surgery and, more specifically, a device to break down biofilm and selectively supply liquid in the mouth.

### BACKGROUND

Prior to an oral procedure, such as dental surgery, the mouth is cleaned and disinfected. To clean the mouth, a mechanical force is applied to remove biofilm which may be on the teeth, gums, or inner cheek surfaces. Antiseptics reduce the chances for post-surgical complications, such as pneumonia. However, clinicians try to limit the amount of antiseptic that is ingested or inhaled by the patient.

### SUMMARY

A dental tool with liquid applicator with a vacuum channel selectively applies a liquid or gel, such as a disinfectant or antiseptic, while physically breaking down biofilm in a patient's mouth, such as on the patient's teeth and gums. The vacuum channel may be connected to a vacuum supply to facilitate an operator applying the vacuum to the patient's mouth to capture debris and excess liquid. The dental tool includes rigid or flexible brush teeth and defines distribution passages in fluid communication with an interior of a chamber that holds the liquid or gel to be applied to the teeth and gums. At least a portion of the chamber is flexible such that pressing the flexible portion (e.g., by putting pressure on the brush teeth against the patient's teeth, etc.) compresses the flexible portion to cause the substance to flow through the distribution passages onto the patient's teeth and gums. After the substance is applied to the patient's teeth and gums, the vacuum channel may be used to remove excess substance and debris from the patient's mouth.

An examples head for a dental tool includes body, a front surface, and a back surface. The body define a chamber to contain a substance and a vacuum channel separate from the chamber to fluidly connect to a vacuum supply. The front surface includes a brush plate with brush teeth. The brush plate defines a wall of the chamber. The front surface also defines distribution holes in fluid connection with the chamber. The back surface is opposite the front surface. The back surface defines a vacuum port in fluid connection with the vacuum channel.

An example dental tool includes a head, a body, and a cap. The head includes a body with a front surface and a back surface. The front surface includes a brush plate with bush teeth. The front surface also defines a plurality of distribution holes. The back surface defines a vacuum port. The body of the head defines a chamber in fluid communication with the plurality of distribution holes and a first vacuum channel in fluid communication with the vacuum port. The body defines a second vacuum channel in fluid connection with the first vacuum channel and a vacuum control closing in fluid connection with the second vacuum channel. The first and second vacuum channels and the vacuum port form a vacuum lumen to, when the dental tool is used, carry debris to be removed from a mouth of a patient. The cap selectively engages the head to protect the brush teeth and plug the plurality of distribution holes.

### BRIEF DESCRIPTION OF THE DRAWINGS

Operation of the present disclosure may be better understood by reference to the following detailed description taken in connection with the following illustrations, wherein:

FIG. 1 illustrates a perspective view of a dental tool with a head and a body with an enlarged view of the head, in accordance with the teachings of this disclosure.

FIG. 2 illustrates another perspective view of the dental tool, in accordance with the teachings of this disclosure.

FIG. 3 illustrates a side view of the dental tool of FIGS. 1 and 2, in accordance with the teachings of this disclosure.

FIG. 4 illustrates a top view of the dental tool of FIGS. 1 and 2, in accordance with the teachings of this disclosure.

FIG. 5 illustrates a cross-section view (D-D) of the dental tool of FIGS. 1 and 2, in accordance with the teachings of this disclosure.

FIG. 6 illustrates a cross-section view (A-A) of the dental tool of FIGS. 1 and 2, in accordance with the teachings of this disclosure.

FIG. 7 illustrates a cross-section view (B-B) of the dental tool of FIGS. 1 and 2, in accordance with the teachings of this disclosure.

FIG. 8 illustrates a perspective view of a head of a dental tool with distribution holes defined in a front surface of the head, in accordance with the teachings of this disclosure.

FIG. 9 illustrates a perspective view of a head of a dental tool with distribution holes defined about a circumference of a front surface of the head, in accordance with the teachings of this disclosure.

FIG. 10 illustrates a cross-section view of the heads of FIGS. 8 and 9,1 in accordance with the teachings of this disclosure.

FIG. 11 illustrates a perspective view of a dental tool with a cap affixed to the head of the dental tool, in accordance with the teachings of this disclosure.

FIGS. 12 and 13 illustrate side views of the dental tool of FIG. 11, in accordance with the teachings of this disclosure.

FIG. 14 illustrates a perspective view of a dental tool of FIG. 11 without the cap affixed to the head of the dental tool, in accordance with the teachings of this disclosure.

FIGS. 15 and 16 illustrate side views of the dental tool of FIG. 11 without the cap affixed to the head of the dental tool, in accordance with the teachings of this disclosure.

### DETAILED DESCRIPTION

Reference will now be made in detail to exemplary embodiments of the present disclosure, examples of which are illustrated in the accompanying drawings. It is to be understood that other embodiments may be utilized and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

As describe below, a dental tool (sometimes referred to as a “toothbrush”) includes bushes or teeth, a chamber (sometimes referred to as a “reservoir”), and a vacuum channel. The dental tool includes a head and a body. The head has a first side (sometime referred to as a “front side” or a “brush side”) and a second side (sometimes referred to as a “back side” or a “vacuum side”) opposite the first side. The front side of the head includes rigid or flexible brush teeth. The head defines distribution passages in the front side that are in fluid communication with an interior of the chamber that holds the antiseptic liquid or gel (e.g., chlorhexidine or chlorhexidine gluconate (CHG), etc.) to be applied to the teeth and gums. At least one wall of the chamber is flexible such that pressing the flexible portion (e.g., by putting pressure on the brush teeth against the patient's teeth, etc.) compresses the flexible portion to cause the substance to flow through the distribution passages onto the patient's teeth and gums. In some examples, the chamber is sized to hold a maximum amount of the substance (e.g., an amount that is equal to or less than a clinically determined maximum amount of the substance during a procedure) can be applied to the teeth and gums by the dental tool to prevent introducing too much of the substance into the patient's mouth. Using pressure of the brush teeth on the patient's teeth to distribute the substance facilitates applying the substance directly to the patient's teeth to reduce the amount of the substance ingested or inhaled by the patient.

The head and the body define a vacuum channel on the interior of the dental tool separated from the chamber that stores the substance. The vacuum channel may be connected to a vacuum supply to facilitate a user applying the vacuum to the patient's mouth to capture debris and excess liquid. The head defines one or more vacuum ports to facilitate applying a vacuum source in fluid connection with the vacuum channel to the mouth of the patient. In some examples, the vacuum port(s) is/are positioned on the back side of the head. The body defines a vacuum control opening to facilitate selectively applying the vacuum source to the vacuum port(s). When the vacuum source is to be applied to the patient's mouth, the vacuum control opening may be blocked (e.g., by a finger of a user, by a sliding cover, etc.). Conversely, when the vacuum source is not to be applied to the patient's mouth, the vacuum control opening may be unblocked. In some examples, a normally-covered secondary vacuum control opening is defined on the body further from the head to provide a backup control in the event that, while in use, the primary vacuum control opening would be placed in the patient's mouth.

In some examples, the brush teeth are flexible and are positioned on a concave surface of the front side of the head to facilitate engaging with three sides of the tooth at the same time. The concave surface forms one wall of the chamber that holds the substance to be applied. A plurality of the flexible teeth define the distribution passages in fluid communication with the interior of the chamber. In some examples, all of the flexible brush teeth define the distribution passages. In some examples, the flexible teeth are integral to the concave wall. The concave wall of the chamber is flexible such that pressing the brush teeth against the teeth of the patient compresses the chamber to distribute the substance through the distribution passages of the flexible brush teeth. In some examples, the vacuum port on the back side of the dental tool is covered by a permeable pad that may be used to wipe off the teeth and gums. The pad provides a permeable barrier between the mouth and the vacuum port such that, when the vacuum supply is applied to the vacuum port (e.g., as controlled by the vacuum control opening), the vacuum flow removes excess substance and debris from the mouth as the substance has been applied.

In some examples, the brush teeth are flexible or semi-rigid that are used to disrupt the biofilm. The brush teeth are positioned on a flexible surface that forms one wall of the chamber that holds the substance to be applied. The distribution passages are defined by the flexible surface or are defined by a combination of the flexible surface and the head (e.g., around the perimeter of the flexible surface. The distribution passages may be defined such that the substance flows through distribution passages under gravitational force, by pressure on the flexible surface (e.g., via the brush teeth in contact with the patient's teeth), or any combination thereof. For example, the distribution passages may be defined based on the viscosity of the substance so that an initial level of flow under gravitational force and a greater level of flow as greater amounts of pressure are applied to the brush teeth to facilitate the user changing the amount of the substance applied as needed. The back side of the head defines at least one vacuum port. In some examples, the back side of the head defines two or three vacuum ports. In some examples, the vacuum port(s) may be define by a combination of the back side of the head and a circumferential wall between the front side and the back side of the head such that portions of the circumferential wall and the back side are in fluid connection with the vacuum channel. Alternatively, in some examples, the back side may be a convex surface such that the back surface intersects the front surface without an intervening wall surface.

In some examples, the dental tool is configured for signal use and is disposable. In some such examples, the devices includes the substance within the bladder and is not refillable. In some examples, a seal or cap is affixed to the front side of the head. The seal or cap is structured to prevent pressure being applied to the chamber while the dental tool is in storage. In such examples, the seal or cap is removed when the user is ready to clean the patient's teeth.

In some examples, at least a portion of a wall separating the chamber and the vacuum channel is removable. In such examples, when the dental tool is manufactured, the substance may be deposited into the chamber and the removable wall may then be snapped or otherwise affixed in place to seal the substance into the chamber. In some examples, to manufacture the dental tool, the dental tool as described herein may be comprised of (a) an upper shell that comprises a portion of the body and the back side of the head, (b) a lower shell that comprises a portion of the body the front side of the head, and the chamber (e.g., five walls that define the chamber, etc.), (c) the removable wall that, when the dental tool is constructed, forms at least a portion of the wall between the chamber and the vacuum channel, and (d) a cap or seal affixable to the front side of the head to protect the flexible wall and the distribution channels from distributing the substance before the dental tool is used.

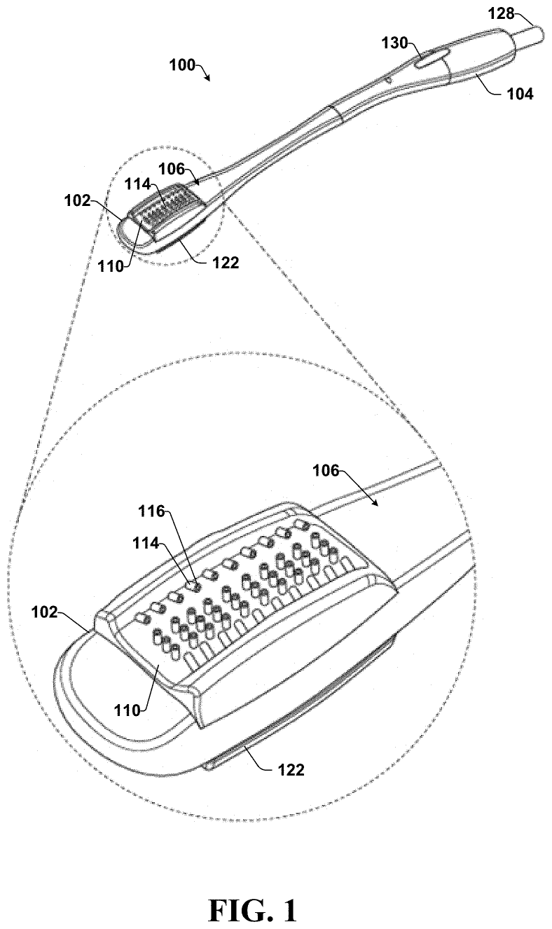

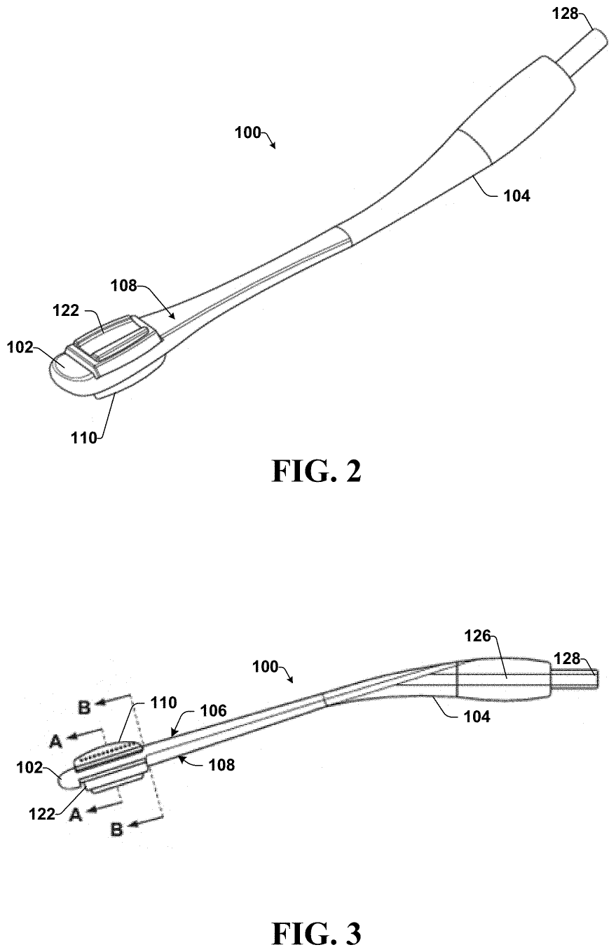

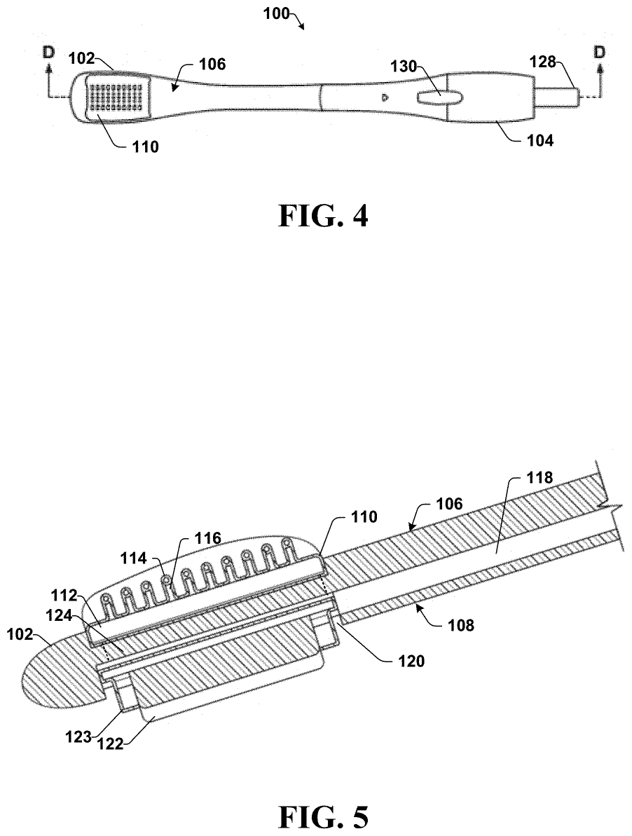

FIGS. 1-7 illustrate an example dental tool 100 that includes a head 102 and a body 104 (sometimes referred to as a “handle”). In some examples, the head 102 is integrally connected to the body 104. Alternatively, in some examples, the head 102 is selectively coupled to the body 104. The head 102 includes a front side 106 and a back side 108. The front side 106 includes a flexible surface 110 (sometimes referred to as a “brush plate”) that, as shown in FIGS. 5-7, forms a wall of a chamber 112 defined by the head 102. In the illustrated example of FIGS. 1-7, the flexible surface 110 is a concave surface to facilitate contact by brush teeth 114 to three sides of teeth of a patient when the dental tool 100 is used to remove biofilm from the mouth of the patient and apply a substance that is stored within the chamber 112. In some examples, the walls of the chamber 112, along with the flexible surface 110 form a flexible bladder that hold the substance to be applied to the patient's teeth and gums.

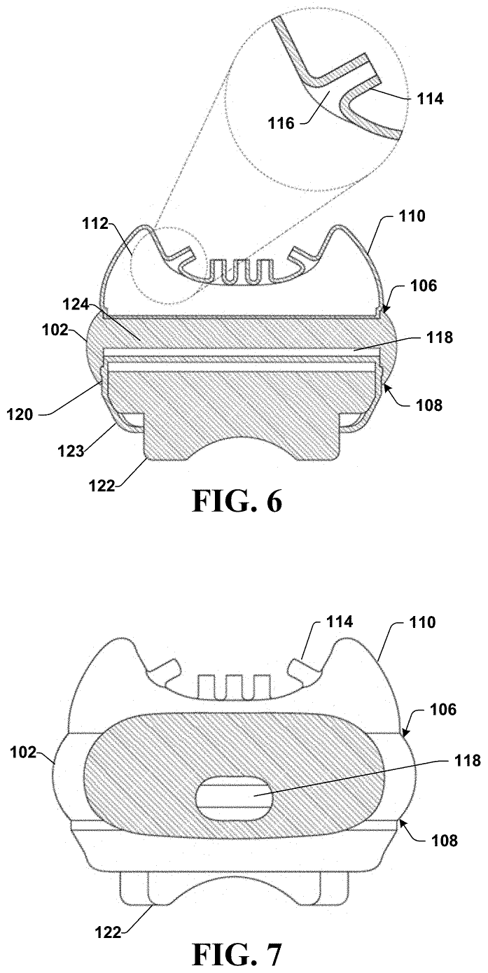

In the illustrated examples of FIGS. 1-7, the brush teeth 114 are flexible (e.g., formed of a flexible polymer) and integral to the flexible surface 110. As best seen in FIGS. 5 and 6, the brush teeth 114 define distribution passages 116 (sometimes referred to as “distribution holes”) that are in fluid communication with the chamber 112. As pressure is placed on the flexible surface 110, substance stored in the chamber 112 flows through the distribution passages 116 in the brush teeth 114. For example, pressure may be placed on the flexible surface 110 when the brush teeth 114 are pressed against the teeth of the patient. Thus, when the dental tool 100 is used to physically brush away debris and biofilm in the patient's mouth, the substance (e.g., the antiseptic material, etc.) is simultaneously applied to the teeth, gums, and/or inner cheeks, etc.

As best illustrated in FIGS. 5, 6, and 7, the head 102 defines a vacuum channel 118 and a vacuum port 120 in fluid connection with the vacuum channel 118. The vacuum port 120 is positioned on the back side 108 of the head 102, opposite the flexible surface 110. In the illustrated examples, a permeable pad 122 is at least partially disposed within the vacuum port 120. The permeable pad 122 facilitates the vacuum channel 118 being fluidly connected external to the head 102 (e.g., to apply the vacuum to a mouth of a patient, etc.) while blocking larger debris that may be generated by the brush teeth 114 removing biofilm form the mouth of the patient. The permeable pad 122 may be, for examples, a sponge or an open cell polymer format the permits the vacuum flow through the vacuum port 120. The permeable pad 122 is held in place within the vacuum port 120 by a retainer 123. The retainer 123 secures the permeable pad 122 within the vacuum port 120 and is configures to have the permeable pad 122 protrude from the retainer 123 and extend beyond the back side 108 of the head 102 to facilitate engaging with the teeth, gums, and inside of the cheek of the patient.

As best illustrated in FIG. 5, a wall 124 separates the chamber 112 from the vacuum channel 118. In some examples, the wall 124 is integral to the head 102. Alternatively, in some examples, the wall 124 is a separate piece from the head 102. In some such examples, the wall 124 is configured to be affixed to the head 102 to fluidly separate the chamber 112 and the vacuum channel 118 after substance has been deposited into the chamber 112.

The body 104 has a first end disposed at the head 102 and a second end configured to be selectively connected to a vacuum flow generator or a vacuum source (e.g., a manually powered squeeze bulb, a manual or powered pump, etc.) For example, the second end of the body 104 may be configured to selectively connect to an electrically powered pump typically used in a surgical suite or a dentist's office that includes an air-liquid separator and a waste reservoir to gather liquid and debris. In the illustrated examples, the body 104 defines a vacuum channel 126 on the interior of the body 102 that is fluidly connected to the vacuum channel 118 of the head 102. The vacuum channel 126 of the body 102 terminates at a port 128 at the second end of the body 102 that is configured to be selectively connected to the vacuum flow generator or the vacuum source. The second end of the body is removably connected to the vacuum source so that the port 128 is fluidly connected to the vacuum source and vacuum flow does not leak at the connection. The connection is releasable and removable so that the dental tool can be removed after use and disposed or cleaned. The vacuum channel 126 is defined along the length of the body 104 from the port 128 at the second end to the first end that interfaces with the head 102. The vacuum channel 126 directs the vacuum flow supplied by the vacuum source through the body 104 to the corresponding vacuum channel 118 of the head 102.

The body defines a vacuum control opening 130 to facilitate selectively applying the vacuum source to the vacuum port 120. When the vacuum source is to be applied to the patient's mouth, the vacuum control opening 130 is blocked (e.g., by a finger of a user, by a sliding cover, etc.). When the vacuum source is not to be applied to the patient's mouth, the vacuum control opening 130 is unblocked. For example, when the user wishes to lessen the vacuum force or reduce it to nothing, the index finger or slider can be slid to expose the vacuum control opening 130 to allow a portion of the vacuum force to be delivered to the vacuum control opening 130 instead of to the vacuum port(s) 120 of the head 102. In some examples, a secondary vacuum control opening may be defines in from of the vacuum control opening 130 (sometimes referred to as the “primary vacuum control opening”) to ensure that the vacuum flow through the body 102 will always have an unsealed vacuum inlet in the unlikely occurrence that the head 102 and body 104 are moved to where a portion of the mount of the patient is vacuum sealed.

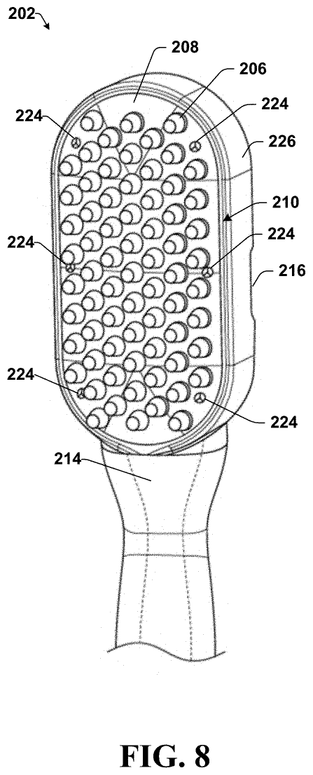

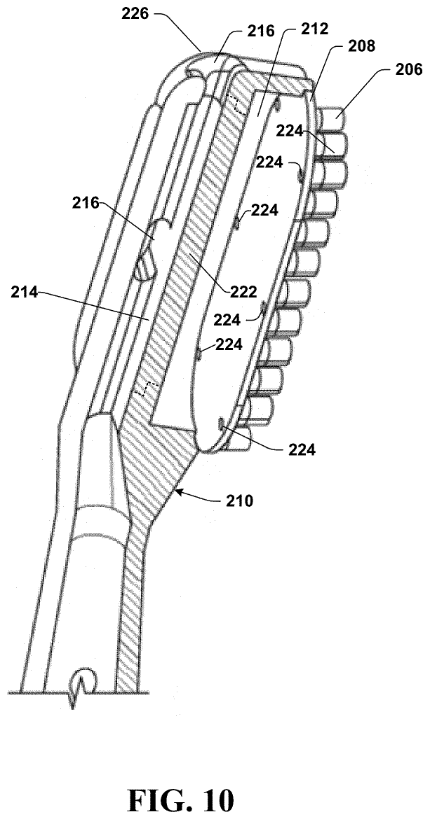

FIGS. 8-10 illustrate heads 202 and 204. In the illustrated examples of FIGS. 8-10, the brush teeth 206 extend from a front surface 208 (sometimes referred to as a “brush plate”) on a front side 210 of the head 202 and 204. As best illustrated in FIG. 10, the head 202 and 204 define a chamber 212, a vacuum channel 214, and one more vacuum ports 216. The vacuum ports 216 are positioned on a back side 218 and/or a side wall 220 of the head 202 and 204. A wall 222 interior to the head 202 and 204 separates the chamber 212 from the vacuum channel 214.

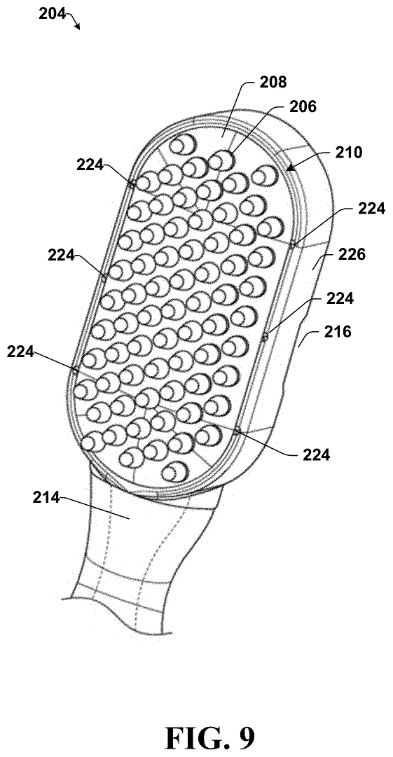

The front surface 208 is one of the walls of the chamber 212. In the illustrated example of FIG. 8, front surface 208 defines distribution passages 224. In some examples, the distribution passages 224 are positioned on an inner circumference of the front surface 208. As illustrated in FIG. 9, the distribution passages 224 may be defined around an outer circumference of the front surface 208 on the body 226 of the head 204. In some examples, the front surface 208 is not flexible. In such examples, substance may flow from the chamber 212 through the distribution passages 224 under the influence of gravity. Alternatively, in some examples, the front surface is flexible. In such examples, substance may flow from the chamber 212 through the distribution passages 224 under the influence of gravity and through pressure exerted on the front surface 208 (e.g., via the brush teeth 206) to compress the chamber 212.

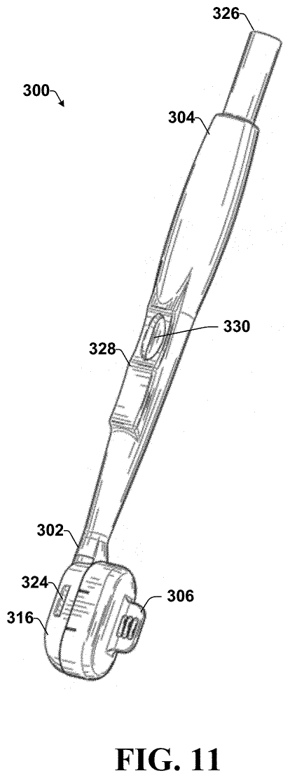

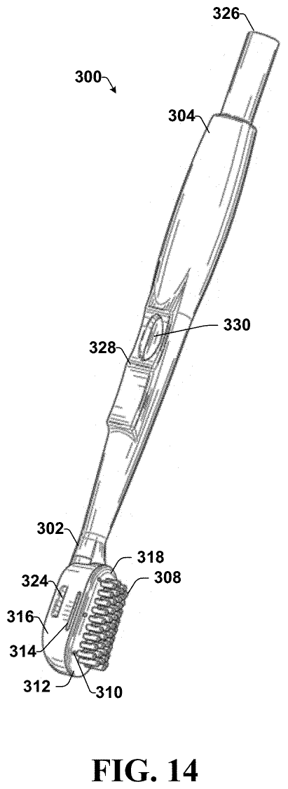

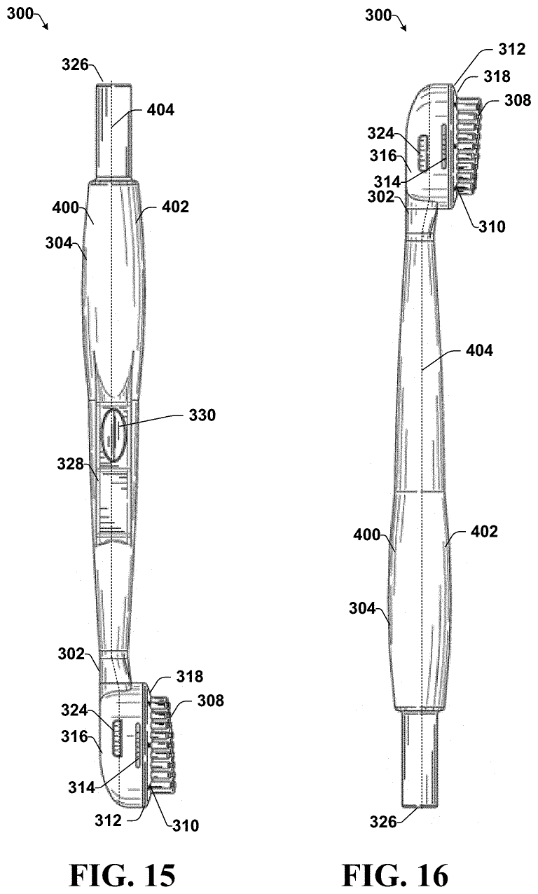

The heads 202 and 204 may be connected to bodies as described in connection with FIGS. 1-7 above (e.g., body 104) and in connection with FIGS. 11-16 below (e.g., body 304). The heads 202 and 204 are connected to the body such that the vacuum channel 214 of the head 202 and 204 is fluidly connected to a corresponding vacuum channel (e.g., vacuum channel 126, the vacuum channel of body 304, etc.) of the body to form a vacuum lumen that carries debris, excess substance, and/or saliva to be removed from the mouth of the patient from the vacuum port(s) 216 to the vacuum source.

FIGS. 11-16 illustrate an example of a dental tool 300. The dental tool 300 includes a head 302 and a body 304. In the illustrated example of FIGS. 11-13, the dental tool 300 includes a removable cap 306 that, when affixed to the head 302, protects brush teeth 308 and/or distribution passages 310 (e.g., prevents or discourages pressure from being exerted on the brush teeth 308 and/or front surface 312 of the head 302, etc.). The cap 306 selectively covers the brush teeth 308. In some examples, the cap 306 includes elongated stems that plug the distribution passages 310 when the cap 306 is engaged with the head 302. In the illustrated examples, the cap 306 is rigid. The head 302 is configured to receive the cap 306. In the illustrated examples, the head 302 defines slots 314 to receive corresponding tabs of the cap 306 that, when installed, snap into the slots 314.

The head 302 defines the front surface 312 and a back surface 316. In the illustrated example, the back surface 316 is a generally concave shape (e.g., a semi-ellipsoid, a rounded cuboid, etc.) such that the back surface 316 is directly connected to the front surface 312. The front surface 312 includes a front plate 318 (sometimes referred to as a “brush plate”). The front plate 318 includes brush teeth 320. The brush teeth 320 may be, for example, bristles or protrusions. In some examples, the front plate 318 is rigid. In some examples, the front plate 318 is flexible. As described in connection with FIG. 8 above, the front plate 318 may define distribution passages 322 that are fluidly connected to a chamber on the interior of the head 302, of which the front plate 318 is one of the walls of that chamber. Alternatively or additionally, in some examples, as described in connection with FIG. 9 above, the front plate 318 and the front surface 312 may define the distribution passages 322 to be positioned about the circumference of the front plate 318.

As described above, the head 302 defines a vacuum channel that is separate from the chamber. The vacuum channel is separated from the chamber by a wall. In some examples, the wall is integral to the head 302. In some examples, the wall is a separate piece that is affixed into the head 302 when the dental tool 300 is manufactured to facilitate depositing a substance into the chamber when the cap 306 is affixed to the head 302. In such examples, the wall is affixed into the head 306 such that the chamber and the vacuum channel are not fluidly connected. The back surface 316 defines vacuum ports 324 that are in fluid communication with the vacuum channel. In some examples the vacuum ports 324 are define on opposing sides of the back surface 316 of the head 302.

The body 304 defines a vacuum channel in fluid communication with the vacuum channel of the head 302. The vacuum channel of the head 302, the vacuum channel of the body 304, and the vacuum ports 324 form a vacuum lumen that carries debris, excess substance, and/or saliva to be removed from the mouth of the patient. The body 304 defines a port 326 in fluid communication with the vacuum channel to connect to a vacuum supply. In the illustrated examples, the body 304 includes a ridge 328 that defines a vacuum control opening 330. The ridge 328 is configured to guide a finger of the user to the vacuum control opening 330 when the user may not be looking at the dental tool 300. In the illustrated example, the ridge 328 includes a depression 332 in which the vacuum control opening 330 is defined.

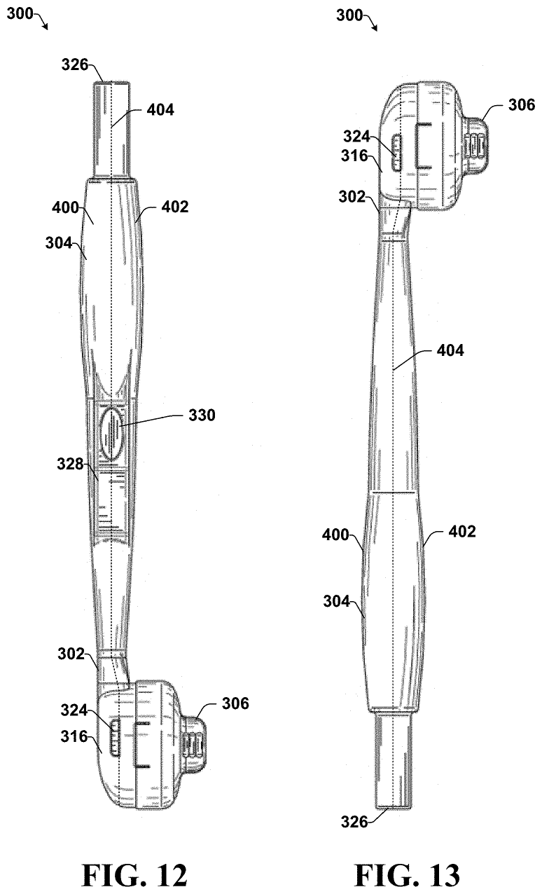

As illustrated in FIGS. 12, 13, 15 and 16, the dental tool 300 may be split into an upper shell 400 and a lower shell 402 alone a medial plane 404. While FIGS. 12 and 13 illustrates the dental tool 300, the other dental tools 100 and 200 described above may be similarly structured into upper and lower shells to facilitate manufacturing. In the illustrated examples, a portion of the head 302 and a portion of the body 304 are integrally connected to form the upper shell 400 and the remaining portions of the head 302 and the body 304 are integrally connected to form the lower shell 402. In some examples, the wall that separates the vacuum channel and the chamber (e.g., the wall 124 of the dental tool 100, the wall 222 of the dental tool 200, etc.) is a separate piece from the lower shell 402 and the lower shell 402. Additionally, in some examples, the front plat 318 is a separate piece from the lower shell 402. When fastened together, the upper shell 400, the lower shell 402, the wall, and the front plat 318 form the dental tool 300 that defines the vacuum channel and the chamber. In an example manufacturing process, dental tool 300 is manufactured by (a) inserting and/or otherwise affixing the front place 318 into the lower shell 402, (b) attaching and/or otherwise affixing the cap 306 to the lower shell 402, (c) depositing a substance into the cavity formed by the lower hell 402 and the front plate 318 that will become the chamber, (d) inserting and/or otherwise attaching the wall to the lower shell 402 to form the chamber and seal in the substance, and (e) attaching and/or otherwise affixing the upper shell 400 to the lower shell 402 to define the vacuum channel and the vacuum port(s) 324.

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. While different heads and bodies of the dental tool have been shown and described, any head described herein may be combined with any body described herein. The claims as follows are intended to include all modifications and alterations insofar as they come within the scope of the claims or the equivalent thereof.

Having thus described the invention, the following is claimed:

1. A head for a dental tool, the head comprising:
a body, the body defining a chamber to contain a substance and a vacuum channel separate from the chamber to fluidly connect to a vacuum supply;
a front surface with a brush plate including brush teeth, the brush plate defining a wall of the chamber, the front surface defining distribution holes in fluid connection with the chamber; and
a back surface opposite the front surface, the back surface defining a vacuum port in fluid connection with the vacuum channel.

2. The head of claim 1, wherein the body includes a separating wall to fluidly separate the chamber and the vacuum channel.

3. The head of claim 2, wherein the separating wall is, before being installed, separate from the body.

4. The head of claim 1, wherein the brush teeth are flexible and integral to the brush plate.

5. The head of claim 4, wherein the brush plate is flexible.

6. The head of claim 5, wherein the brush plate of the front surface is concave.

7. The head of claim 4, wherein the distribution holes are defined in a plurality of the brush teeth.

8. The head of claim 1, wherein the distribution holes are defined on the brush plate.

9. The head of claim 1, wherein the distribution holes are defined on an outer circumference of the brush plate.

10. The head of claim 1, including a permeable pad disposed within the vacuum port.

11. The head of claim 1, wherein the back surface is concave with first and second sides, wherein the vacuum port is a first vacuum port defines on the first side, and wherein the back surface defines a second vacuum port on the second side opposite the first vacuum port defined on the first side.

12. A dental tool comprising:
a head comprising a body with a front surface and a back surface,
the front surface comprising a brush plate with bush teeth, and defining a plurality of distribution holes,
the back surface defining a vacuum port;
the body defining a chamber in fluid communication with the plurality of distribution holes and a first vacuum channel in fluid communication with the vacuum port;
a body defining a second vacuum channel in fluid connection with the first vacuum channel and a vacuum control closing in fluid connection with the second vacuum channel, wherein the first and second vacuum channels and the vacuum port form a vacuum lumen to, when the dental tool is used, carry debris to be removed from a mouth of a patient; and
a cap to selectively engage the head to protect the brush teeth and plug the plurality of distribution holes.

13. The dental tool of claim 11, wherein the body includes a ridge which the vacuum control opening is defined.

14. The dental tool of claim 11, wherein the head includes a separating wall to fluidly separate the chamber and the vacuum channel.

15. The dental tool of claim 11, wherein the brush teeth are flexible and integral to the brush plate.

16. The dental tool of claim 11, wherein the brush plate is flexible.

17. The dental tool of claim 11, wherein the brush plate of the front surface is concave.

18. The dental tool of claim 11, wherein the distribution holes are defined in a plurality of the brush teeth.

19. The dental tool of claim 11, wherein the distribution holes are defined on the brush plate.

20. The dental tool of claim 11, wherein the distribution holes are defined on an outer circumference of the brush plate.
